(19) United States
(12) Patent Application Publication
(10) Pub. No.: US 2009/0091658 A1
(43) Pub. Date: Apr. 9, 2009

(54) AV SYSTEM

(75) Inventor: Tatsuo Hirose, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/282,922

(22) PCT Filed: Apr. 5, 2007
(86) PCT No.: PCT/JP2007/057646

§ 371 Date: Sep. 15, 2008

(30) Foreign Application Priority Data
Apr. 17, 2006 (JP) 2006-113149

(51) Int. Cl. H04N 5/50

(52) U.S. Cl. 348/569; 348/E05.099

(57) ABSTRACT

The AV system is an AV system comprising a display device and a plurality of AV appliances including an AV appliance having plural functions connected by way of a digital interface, in which the types of plural AV functions, and information of input and output of video signal and audio signal are acquired by way of the digital interface, and icons of plural AV appliances, and the connection state diagram showing the flow of video signal and audio signal are displayed on the display device, and the AV appliances can be operated from the connection state diagram. In this AV system, the connection relation of AV appliances, and the flow of video and audio signals can be recognized intuitively, and the appliances can be operated easily from the television screen.

### TECHNICAL FIELD

The present invention relates to an AV system to which a plurality of AV appliances are connected, and more particularly to an AV system, in an AV appliance having a display unit, capable of displaying the connection state or operation state of the connected AV appliance in a display unit, and changing the connection state or operation state.

### BACKGROUND ART

Hitherto, in an AV system to which a plurality of AV appliances are connected, in operation of appliances such as input changeover from each AV appliance, plugging and unplugging of AV cables and remote control of individual appliances are individually required, and the operation is complicated.

Patent document 1 discloses a connection state display method, in which flows of video signals and audio signals of a plurality of AV appliances are shown on a screen of a display device.

In the connection state display method of patent document 1, when an AV appliance having plural AV functions is connected, the display and setting of flows of video signals and audio signals of plural functions cannot be changed. An AV appliance having plural AV functions is, for example, a DVD recorder having a built-in HDD.
Patent document 1: Unexamined Japanese Patent Publication No. H9-154077

### SUMMARY OF THE INVENTION

The AV system is an AV system to which a plurality of AV appliances including an AV appliance having plural functions are connected, in which the AV appliance having a display unit out of the plurality of AV appliances includes a digital interface for inputting and outputting physical address and type information of the plurality of AV appliances, and input and output information of video signals and audio signals, a memory unit for storing the physical address, type information, and input and output information received by way of the digital interface, a control unit for judging the connection state of plural connected appliances based on the information stored in the memory unit, and outputting image signals showing the connection state of the plurality of AV appliances, and an image synthesizer for synthesizing the image signal showing the connection state outputted from the control unit with other image signal, and adding to the display unit.

### BRIEF DESCRIPTION OF THE DRAWINGS

FIG. 1 is a block diagram of an entire AV system in a preferred embodiment of the present invention.

FIG. 2 is a connection state diagram of a plurality of AV appliances in a preferred embodiment of the present invention.

FIG. 3 is an outline diagram of configuration of HDMI.

FIG. 4 is a flowchart showing the flow of making a connection state diagram of a plurality of AV appliances in a preferred embodiment of the present invention.

FIG. 5 is a diagram showing logical addresses assigned to a plurality of AV appliances in a preferred embodiment of the present invention.

FIG. 6 is a diagram showing appliance codes in a preferred embodiment of the present invention.

FIG. 7 is a diagram showing information of video and audio input and output in a preferred embodiment of the present invention.

FIG. 8 is a connection state diagram in a preferred embodiment of the present invention.

FIG. 9 is a diagram showing a state after updating of a connection state diagram in a preferred embodiment of the present invention.

FIG. 10 is a flowchart showing the flow of appliance operation from a connection state diagram in a preferred embodiment of the present invention.

FIG. 11 is a diagram of a screen showing appliance operation from a connection state diagram in a preferred embodiment of the present invention.

### DESCRIPTION OF THE REFERENCE NUMERALS AND SIGNS

100 Television receiver (television)
101 Display unit
102 Remote controller
103 Remote control receiver
104 Control unit
105 Memory unit
106 Selector unit
107 Image synthesizer
108, 109, 110 Digital interface receiver
111, 112, 113 Digital interface transmitter
114, 115, 116 HDMI cable
117 Set-top box (STB)
118 Analog interface transmitter
119 AV amplifier
120 HDD-incorporated DVD recorder
121 Analog interface receiver
122 Analog AV cable
301 Transmitter
302 TMDS encoder
303 Transmission control unit
304 Receiver
305 TMDS decoder
306 Reception control unit
307 CEC control line
308 DDC line
1101 Cursor
1102 Operation list menu

### DETAILED DESCRIPTION OF THE PREFERRED EMBODIMENTS

The present invention is intended to solve the problems of the prior art, and present an AV system connecting AV appliances having a plurality of AV functions, being capable of displaying the flow and state of video signals and audio signals in each function unit, and setting and changing appropriately on a screen.

Preferred embodiments of the present invention are specifically described below.

### Preferred Embodiment 1

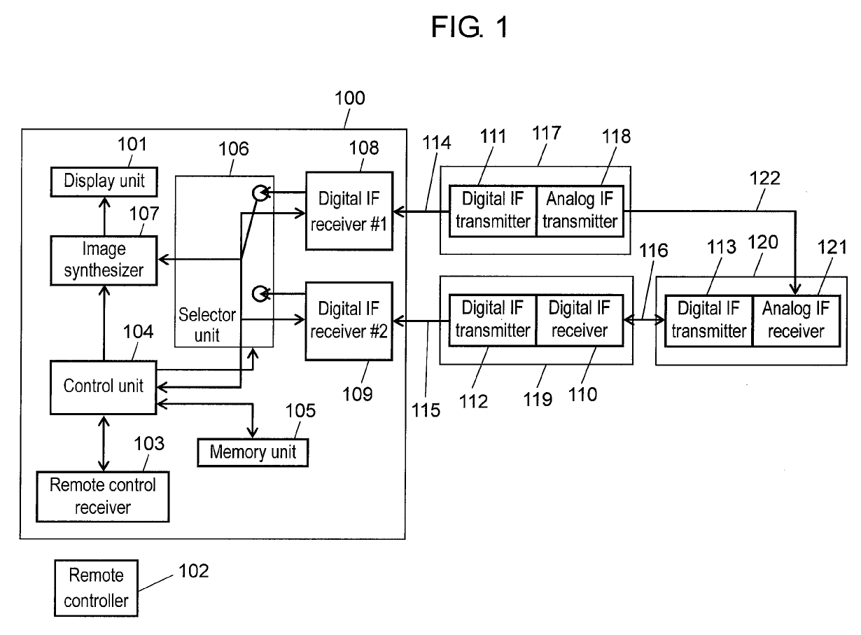

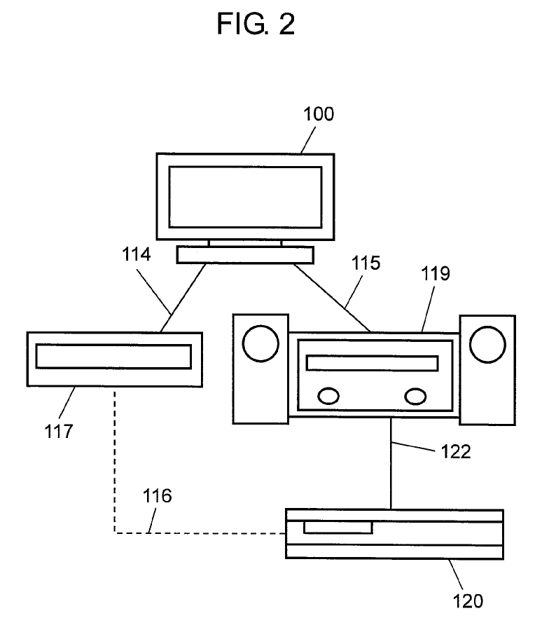

FIG. 1 and FIG. 2 are block diagrams of an AV system having a plurality of AV appliances according to the present invention. Herein, the plurality of AV appliances are connected by way of HDMI (high definition multimedia interface). The HDMI is an example of digital interface, and the detail of the HDMI is described below.

As shown in FIG. 2, the AV system is composed of television receiver 100 (hereinafter referred as television 100), set-top box 117 (hereinafter referred as STB 117), AV amplifier 119, and HDD-incorporated DVD recorder 120. HDD-incorporated DVD recorder 120 is an example of AV appliance having a plurality of AV functions. Television 100 has two systems of HDMI interface. Television 100 is connected to STB 117 by way of HDMI cable 114, and is connected to AV amplifier 119 by way of HDMI cable 115. In this manner, television 100 is connected to a plurality of AV appliances. HDD-incorporated DVD recorder 120 is connected to AV amplifier 119 by way of HDMI cable 116, and is connected to STB 117 by way of analog AV cable 122. The plurality of AV appliances to be connected to television 100 are STB 117, AV amplifier 119, and HDD-incorporated DVD recorder 120 in this example. In FIG. 1, only part of individual AV appliances in FIG. 2 is shown.

In FIG. 1 and FIG. 2, STB 117 and HDD-incorporated DVD recorder 120 are connected by way of analog AV cable 122, instead of HDMI cable. This is because it is not permitted to record video signals and audio signals through HDMI cable, and it is required to connect with analog AV cable for recording video and audio signals.

This preferred embodiment of the present invention is more specifically described below while referring to FIG. 1 as an example.

Television 100 is used for displaying the video and producing the audio from broadcast waves or external inputs. In television 100, display unit 101 displays the video and produces the audio. Display unit 101 is, for example, composed of a CRT, liquid crystal panel, or plasma display panel, and speakers. The user controls television 100 by using remote controller 102. Remote control receiver 103 receives a signal from remote controller 102. Control unit 104 is, for example, a CPU for controlling television 100 entirely and making a connection state diagram as described below. Memory unit 105 stores the connection information acquired from each AV appliance as described below. Selector unit 106 selects video signals and audio signals from the plurality of appliances connected to television 100. Image synthesizer 107 superposes a video signal selected by selector unit 106, and a connection state diagram compiled by control unit 104, and sends to display unit 101. Digital interface receivers 108, 109, 110 and digital interface transmitters 111, 112, 113 execute the digital interface between AV appliances. In FIG. 2, “the digital interface receiver” is shown as “the digital IF receiver”, and “the digital interface transmitter” is shown as “the digital IF transmitter”. In preferred embodiment 1, the digital interface is HDMI. HDMI cables 114, 115, 116 transmit video signals, audio signal, and control data.

STB 117 has digital broadcast receiving function and digital interface transmitter 111, and can transmit the received video signal, audio signal and control data. STB 117 also has analog interface transmitter 118 for sending out analog video signal and audio signal. AV amplifier 119 is provided with digital interface transmitter 112 and digital interface receiver 110, and has a function of decoding an audio signal and sending out to an internal speaker, and a repeater function of relaying video signal and audio signal. HDD-incorporated DVD recorder 120 has functions of reproducing video signal and audio signal in the HDD and DVD, and recording video signal and audio signal in the HDD and DVD, and digital interface transmitter 113. HDD-incorporated DVD recorder 120 can transmit the video signal, audio signal and control data in the HDD and DVD. HDD-incorporated DVD recorder 120 also has analog interface receiver 121 for receiving analog video signal and audio signal, and can also record the analog video signal and audio signal in the HDD or DVD. Analog AV cable 122 transmits analog video signal and audio signal.

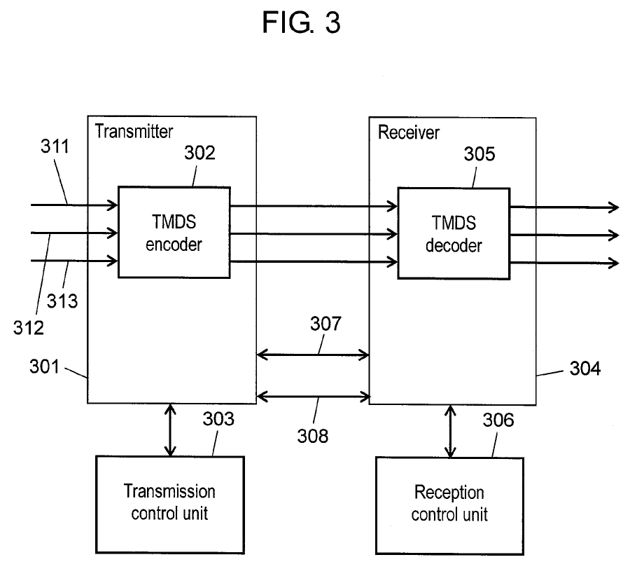

The configuration of HDMI is specifically described while referring to FIG. 3. The HDMI is composed of transmitter 301 and receiver 304. Transmitter 301 is included in the STB, DVD, VTR and other source devices of video and audio signal, and receiver 304 is included in the display unit, and other display and output devices of video and audio signals. Transmitter 301 and receiver 304 are connected with each other by way of HDMI cable.

Transmitter 301 transmits video signals (Y311, Pb312, Pr313) and audio signals (IEC958) to receiver 304, in a format suited to high speed transmission by TMDS encoded in TMDS encoder 302. TMDS encoder 302 converts the video data from video data of parallel 8 bits×3 channels into serial 10 bits×3 channels, and converts the audio data from audio data of parallel 4 bits into serial 10 bits. Transmission control unit 303 controls transmitter 301. Receiver 304 decodes the video data and audio data sent from transmitter 301 by TMDS decoding, and reproduces video data and audio data of base band. TMDS decoder 305 converts the video data of serial 10 bits into parallel 8 bits, and converts the audio data of serial 10 bits into parallel 4 bits. Reception control unit 306 controls receiver 304. Transmission control unit 303 and reception control unit 306 can store the ID, physical address, and logical address of AV appliances. An appliance control line, that is, CEC (consumer electronics control) control line 307 transmits control signals of consumer electronic appliances. DDC (display data channel) line 308 transmits control signals of the display. Using CEC control line 307 and DDC line 308, two-way communications are possible between reception control unit 306 and transmission control unit 303.

In preferred embodiment 1 having such configuration, the AV system is more specifically described below.

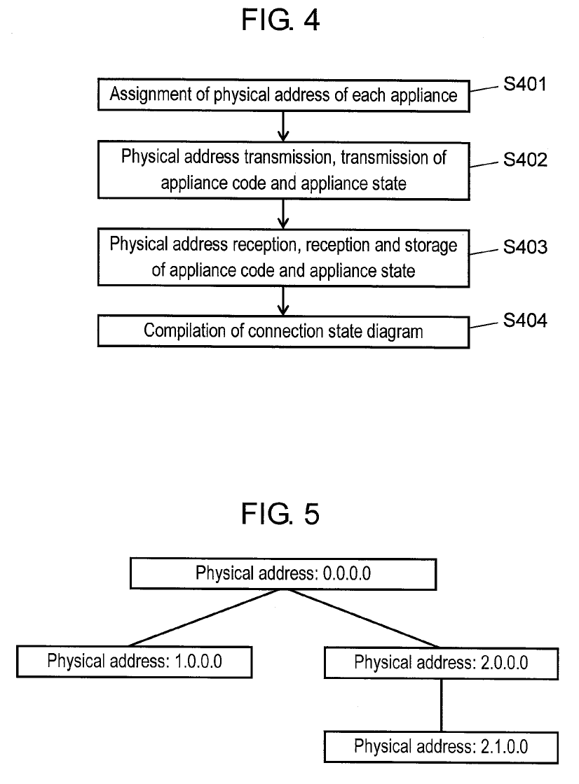

First of all, a method of compiling an AV appliance connection diagram is explained in FIG. 4. Herein, in the AV system connected as shown in FIG. 2, the following operation and connection are supposed. That is, television 100 displays the image of HDMI input from AV amplifier 119, and STB 117 receives the broadcast wave, and sends out the video and audio to the digital (HDMI) output and analog output. HDD-incorporated DVD recorder 120 reproduces the DVD, and sends out the video and audio of the digital (HDMI) output, and records the video and audio from an analog input into the HDD. AV amplifier 119 sends through the video from the digital (HDM) input to the digital (HDMI) output, and decodes the audio and sends out to the internal speaker.

At step S401, when all AV appliances having HDMI interfaces detect an electrical connection, a physical address is assigned. The physical address is expressed in four digits, and the physical address of television 100, which is a display device, is assumed to be a tree structure of connection relation of root node of 0.0.0.0, and the physical addresses are assigned depending on the parental relation and fraternal relation from the root node. The physical address of each AV appliance is stored in the connected reception control unit 306.

FIG. 5 shows a diagram of assignment of physical address of each appliance in the connection example in FIG. 1. The root node, that is, the physical address of television is 0.0.0.0. In the physical address of STB 117 as a first AV appliance in a first layer, 1.0.0.0 is assigned, and in the physical address of AV amplifier 119 as a second AV appliance in the first layer, 2.0.0.0 is assigned, and in the physical address of HDD-incorporated DVD recorder 120 as a first appliance in a second layer, 2.1.0.0 is assigned.

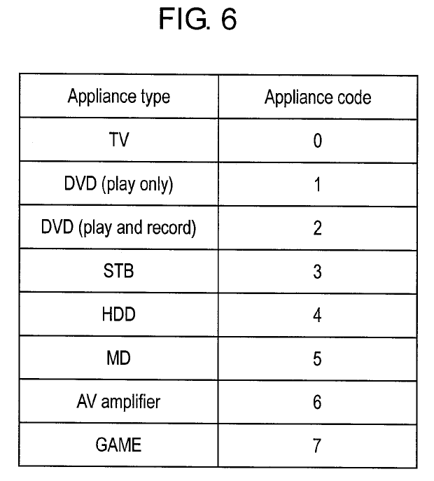

At step S402, these assigned physical addresses, appliance codes, and video and audio input and output information are transmitted from each AV appliance to television 100. The appliance codes are the specific codes defined by the type of appliances preliminarily stored in the AV appliances. FIG. 6 is an appliance code table in preferred embodiment 1. For example, when “the type of appliance” is the “television”, “the appliance code” is “0”, when “the type of appliance” is “DVD (play only)”, “the appliance code” is “1”. In the appliance having plural AV functions, plural appliance codes are stored, and plural codes are transmitted to television 100.

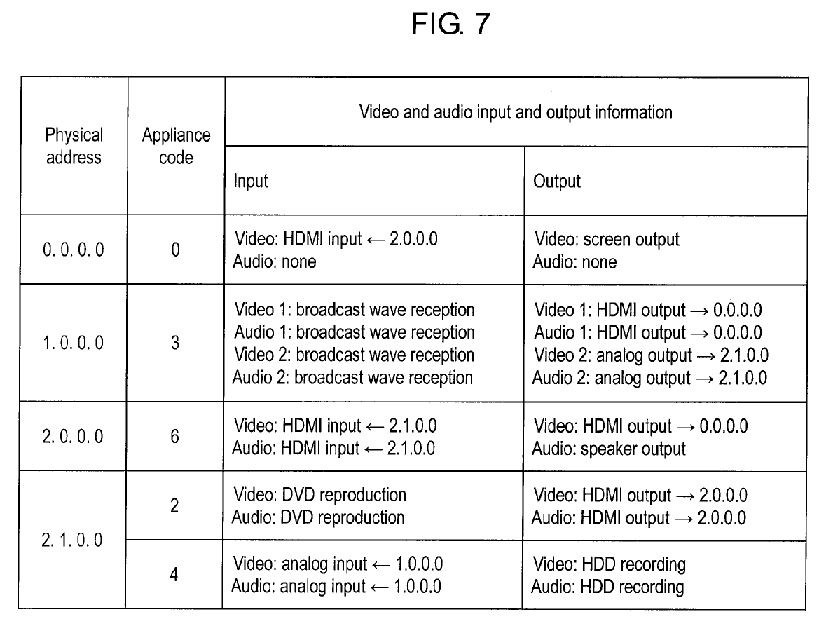

In preferred embodiment 1, the video and audio input and output information shows the present state of the AV appliance, and is the information of operation state such as reproducing mode, stopping mode, recording mode, and video receiving mode, and the input and output of video signal and audio signal. FIG. 7 shows the input and output information of each AV appliance in the connection and configuration in FIG. 1. As shown in FIG. 7, the present status of physical address of each AV appliance, the appliance code of each AV appliance, and the video and audio input and output information of each AV appliance are defined. The “input” column of video and audio input and output information is for defining the present status of the type of signal and format and signal source of input interface. The “output” column of video and audio input and output information is for defining the destination of the type of output signal and format and signal source of input interface. Herein, STB 117 and HDD-incorporated DVD recorder 120 are connected with each other by way of analog AV cable 122, and usually the connection relation cannot be judged. In preferred embodiment 1, therefore, the connection relation is recognized as follows. First, from the transmission side of video signal and audio signal, that is, from the STB 117 side, the physical address and the appliance code are transmitted to the reception side of HDD-incorporated DVD recorder 120 by making use of the blanking period of video signal. HDD-incorporated DVD recorder 120 takes out the physical address and appliance code from the blanking period of the video signal transmitted from the STB 117 side, and transmits to television 100 as video and audio input and output information. By using such means, the connection relation of AV appliances not connected by way of digital interface (HDMI) can be acquired.

At step S403, the physical address, appliance code, and video and audio input and output information transmitted from each AV appliance are received in television 100 and stored in memory unit 105.

At step S404, the physical address, appliance code, and video and audio input and output information stored in memory unit 105 are analyzed, and an AV appliance connection diagram is compiled.

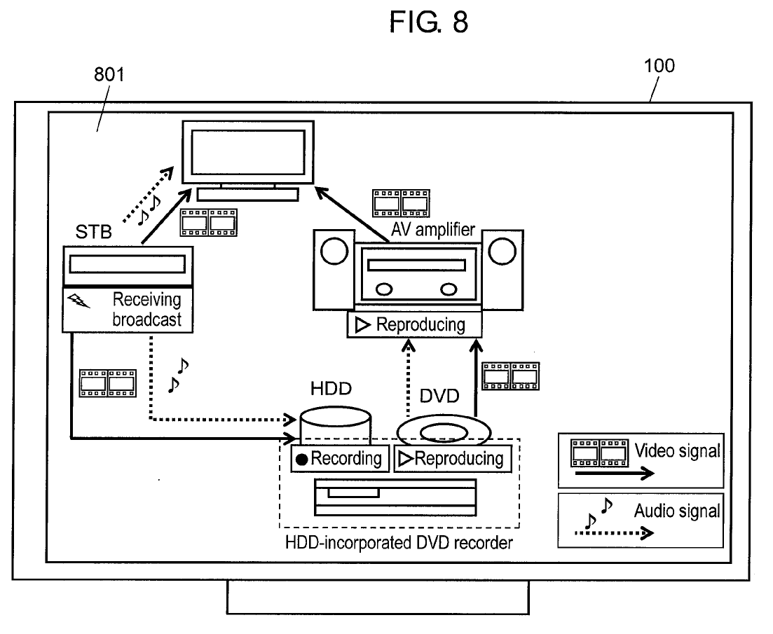

A method of compiling an AV appliance connection diagram is explained by referring to FIG. 8.

First, using the physical address and the appliance code, the icon of the connected AV appliance and the characters showing the types are displayed on screen 801 of television 100. The icon is displayed at a proper position so as not to overlap by using an appropriate algorithm by a tree structure according to the physical address. When displaying an AV appliance having plural functions, plural icons expressing the functions are displayed on the icon of one appliance, such as “HDD-incorporated DVD recorder” in FIG. 8.

The icons preliminarily registered in television 100 may be displayed, or irons may be registered in individual AV appliances, and the icon of each AV appliance may be acquired by way of the digital interface (HDMI), and displayed. In the latter method, in the case of the icon of the AV appliance of same type, the icon may be changed depending on the type number or the like, and the appliance can be identified more intuitively.

Next, using the video and audio input and output information, the flow of video signal and audio signal and the connection relation are indicated by arrows. FIG. 8 shows the flow of video signal by a solid-line arrow and a film-like icon, and shows the flow of audio signal by a dotted-line arrow and a musical note-like icon. The flow of video signal and audio signal from STB 117 to television 100 is indicated in pale-gray color because the signals are not actually delivered from the television.

Similarly, using the video and audio input and output information, the state of the AV appliance is indicated near the icon of each AV appliance. In FIG. 8, STB 117 is receiving broadcast, HDD-incorporated DVD recorder 120 is reproducing the DVD and recording in the HDD, and AV amplifier 119 is reproducing the audio, and the character strings and icons showing these states are displayed.

In this way, screen 801 displays the type of AV appliances, connection state between AV appliances, and connection data of all systems of the AV system shown in FIG. 1 and FIG. 2, in a clearly understandable manner. This screen making is executed by control unit 104 by making use of information stored in memory unit 105 (such as information shown in FIG. 7).

If the connection state or connection relation of the connected AV appliances is changed, the connection state diagram is updated as shown below.

When the state of the AV appliance is changed, the AV appliance transmits the physical address, the appliance code, and the video and audio input and output information again to television 100. Television 100 receives the information and stores in storage unit 105, and analyzes the differential information by comparing with the preliminarily stored information, and updates the connection state diagram by depicting the differential information.

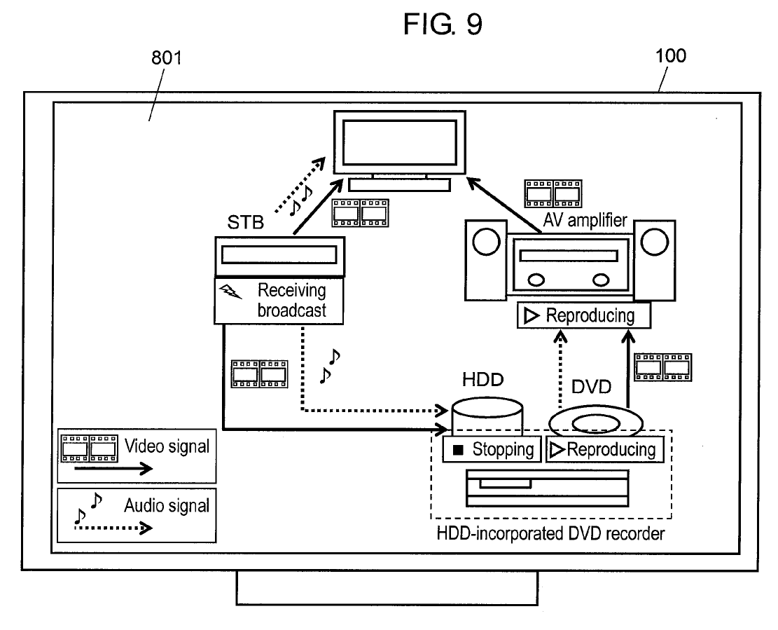

For example, if the HDD recording of HDD-incorporated DVD recorder 120 is stopped, an example of updating the diagram is explained by referring to FIG. 9. FIG. 9 is a connection state diagram when recording of HDD of HDD-incorporated DVD recorder 120 is stopped.

When recording of HDD is stopped, HDD-incorporated DVD recorder 120 transmits the video and audio input and output information again to television 100. Television 100 receives the information of the appliance of transmitted physical address 2.1.0.0, and compares with the information of physical address 2.1.0.0 previously stored in storage unit 105. As a result of comparison, the operation of appliance code “4” of physical address 2.1.0.0 corresponding to video signal and audio signal is changed from recording to stopping, and control unit 104 erases the characters and the icon of recording being displayed on the HDD icon of the connection state diagram, and displays the characters and the icon of stopping. The flow of video signal and audio signal from STB 117 to HDD of HDD-incorporated DVD recorder 120 is continuing, and the arrow indication of video signal and audio signal remains in FIG. 9, but the HDD side is changed to a pale-gray color because it is stopped.

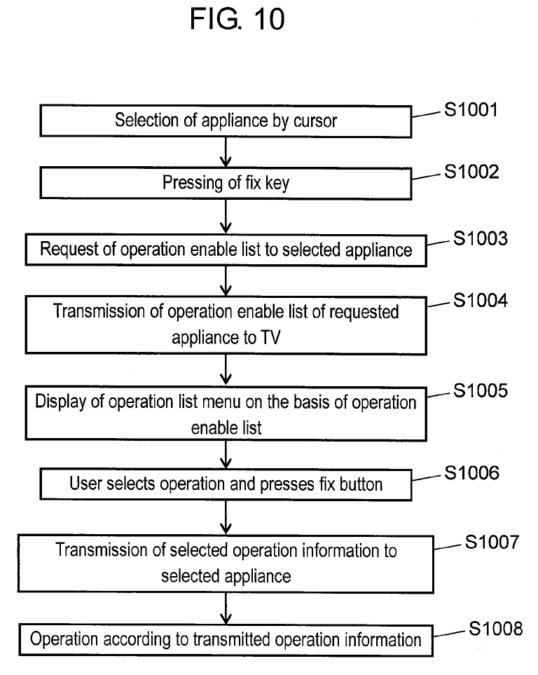

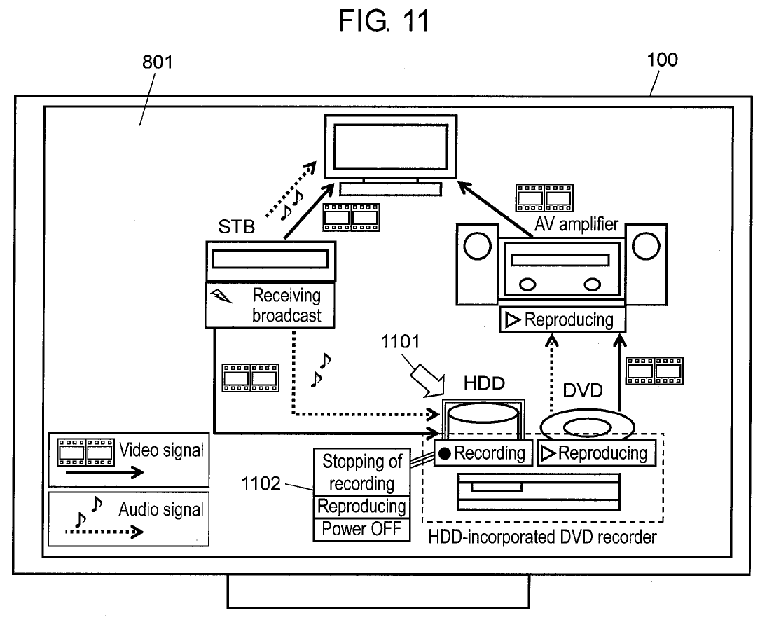

A method of executing the operation of each AV appliance on the connection state diagram is explained by referring to FIG. 10 and FIG. 11. The user controls the operation of connection diagram state by using remote controller 102. Remote controller 102 is provided at least with up, down, right, and left cursor keys and a fix button.

At step S1001, the user manipulates the cursor of remote control 102, and selects the icon of a desired AV appliance. Arrow 1101 in FIG. 11 is a cursor, and depending on the manipulation of remote controller 102, it moves along on the appliances on screen 801. At step S1002, the user selects the desired AV appliances, and presses the fix button. At step S1003, television 100 sends an inquiry to the selected AV appliance about executable operation.

At step S1004, the inquired AV appliance sends a list of presently executable operations to television 100. At step S1005, television 100 displays operation list menu 1102 on the connection state diagram based on the operation list transmitted from the AV appliance. When television 100 is selected, an operation list capable of executing the television is displayed. Operation list menu 1102 is displayed near the selected appliance, and can be selected by cursor up/down key.

When the user selects operation list menu 1102, the operation is as explained below.

At step S1006, the operation list can be selected by up/down button of the remote controller, and the fix button is pressed. At step S1007, television 100 transmits the operation selected by operation list menu 1102 to the selected AV appliance. At step S1008, the AV appliance receiving the operation changes the state of the appliance according to the operation. The AV appliance changed in the state transmits the state of the appliance to television 100, and television 100 updates the connection state diagram in the same manner of diagram updating mentioned above.

In the above explanation, the HDMI is used as an example of digital interface for connecting the AV appliances. But the HDMI is only an example of digital interface, and the present invention is not limited to the HDMI alone.

Also in the above explanation, the connection state diagram is displayed in display unit 101 of television 100, but the display position of connection state diagram is not limited to display unit 101 of television 100. That is, the present invention is not limited to display unit 101 of television 100, the connection state diagram may be displayed in any AV appliance having display function, and same functions and effects of the present invention are realized.

In such configuration, on a display device in which a plurality of AV appliances having plural AV functions are connected, the connection state diagram showing the state of plural AV functions and flow of video and audio signals can be displayed. Further, by allowing to operate each AV function from the connection state diagram, the state of each AV appliance and the connection state can be understood easily, and the AV system can be handled easily without plugging or unplugging the cables or without requiring complicated manipulation of plural remote controllers. As a result, the user is liberated from complicated operation, and can easily judge the appliance presently reproducing the video and audio signals.

### INDUSTRIAL APPLICABILITY

The present invention relates to a display device in which a plurality of AV appliances are connected, and the display device shows the connection state and operation state of the connected AV appliances, and it is very useful as the AV system capable of changing the connection state and operation state easily.

1. An AV system comprising:
a plurality of AV appliances, which includes an AV appliance having a plurality of functions, connected,
wherein the AV appliance having a display unit out of the plurality of AV appliances includes:
a digital interface for inputting and outputting at least one of physical address of the plurality of AV appliances, type information of the plurality of AV appliances, and input and output information of video signals and audio signals of the plurality of AV appliances,
a memory unit for storing the physical address, type information, and input and output information received by way of the digital interface,
a control unit for judging a connection state of the plurality of AV appliances connected based on the information stored in the memory unit, and outputting image signals showing the connection state of the plurality of AV appliances, and
an image synthesizer for synthesizing the image signal showing the connection state outputted from the control unit with another image signal, and adding it to the display unit.

2. The AV system of claim 1,
wherein the AV appliance having the display unit further includes:
a remote control receiver for receiving a signal from a remote controller,
the control unit forms the image signal showing the connection state into an image including an operation list menu based on an instruction from the remote controller, and
the control unit commands an operation of the menu specified in the operation list menu to a specified AV appliance by way of the digital interface based on the instruction from the remote controller.

3. The AV system of claim 1,
wherein the control unit updates the image signal showing the connection state of the plurality of AV appliances,
when detecting a difference between the type information of the plurality of AV appliances, at least one input and output information of the video signal and the audio signal of the plurality of AV appliances, and the information already stored in the memory unit.

4. The AV system of claim 1,
wherein the digital interface is HDMI.
